(19) United States
(12) Patent Application Publication
(10) Pub. No.: US 2008/0209480 A1
(43) Pub. Date: Aug. 28, 2008

(54) METHOD FOR ENHANCED VIDEO PROGRAMMING SYSTEM FOR INTEGRATING INTERNET DATA FOR ON-DEMAND INTERACTIVE RETRIEVAL

(76) Inventors: Kurt S. Eide, Seattle, WA (US); Gavin James, Seattle, WA (US)

Correspondence Address: AXIOS LAW GROUP. PLLC, 1525 FOURTH AVENUE, SUITE 800, SEATTLE, WA, 98101, US

(21) Appl. No.: 11/960,510

(22) Filed: Dec. 19, 2007

Related U.S. Application Data
(60) Provisional application No. 60/871,073, filed on Dec. 20, 2006.

(51) Int. Cl. H04N 7/173

(52) U.S. Cl. 725/87

(57) ABSTRACT

A digital information system and method are provided herein.

### RELATED REFERENCES

This application is based upon and claims the benefit of priority from Provisional Application No. 60/871,073 filed Dec. 20, 2006, the entire contents of which are incorporated herein by reference.

### BACKGROUND

In today's Internet age, instantaneous access to volumes of diverse information and consumer opportunities has rapidly become a societal norm, accepted by many as a large component of everyday life. As technology advances are quickly adopted, user expectations increase; every new avenue of content delivery becomes an opportunity for immediate access to information and commerce.

One popular type of Internet technology advancement is in online video delivery, creating a bridge between the global Web and the traditional television and film viewing experience. Now, both professional and amateur video content are becoming standard online fare, supported by broadband Internet access that is now more readily available and affordable to the masses. This increase in easy access to video content introduces new demands for information, which current technology does not effectively address because there exists no seamless bridge between video and the vast educational and commercial resources of the Internet.

For example, when a person watches a video (online or on a television set) they have no means of accessing any information, much less context-specific information, related to what they are viewing. Currently, they must switch to a separate interface to conduct search queries. More than a time-consuming nuisance, this extra step in fact creates a significant problem with regard to obtaining relevant information. Because viewing video and searching for information are two distinctly separate operations, handled with two distinctly separate interfaces, often the specific visual or audio context behind the person's search, their true intention, is lost. Finding precisely relevant information relies on the viewer's ability to ask the right questions and find the right answers, rather than technology doing it for them by accurately and seamlessly connecting a specific video element with related information.

Furthermore, creating useful search queries can be difficult or impossible when one's question about specific video content may be vague, obscure, or complex. For instance, their question might be, “Who made the sofa in Woody Allen's apartment in the movie ‘Manhattan’—and where could I buy one like it?” To find context-specific information such as this, even a very sophisticated search query would likely produce an overwhelming volume of irrelevant results, perhaps even nothing of any value to the viewer.

Another side to this problem is that any information provided that relates to a given video is pre-determined by video programmers and auto-delivered to viewers; the element of viewer choice is often non-existent. Viewers have little ability to randomly interact with video content to enjoy on-demand access to information and consumer resources related to a specific element in the video.

Where there are emerging technologies attempting to bridge this gap between video and Internet information access, they are limited to specific platforms or file formats. There exists no platform-independent solution that supports multiple video file formats and media players.

An additional drawback of current video technology is that supplemental content, such as “Director's Commentary” frequently included on DVDs, is typically an all or nothing feature. The viewer must choose to either play the entire session concurrent with the main video, view it separately, or turn it off altogether. There currently exists no way to watch a video and select at random a specific scene in order to access supplemental information relevant to that scene.

Yet another limitation of current video technology is that it has not yet caught up with the rapidly growing trend of multi-tasking viewers, i.e., individuals who watch video and simultaneously send email, instant messages, or cellular phone text messages about what they are viewing. Similar to the search query problem, these actions must all be conducted with separate interfaces, even separate devices, leaving users with no ability to communicate their messages in synch with specific visual or audio context from a video they're watching. Anything they want to say about a certain video element, such as an actor, location, object, or audio component, must rely on the viewer's own description and be communicated forward to others, who will experience it out of context with the video.

Along those lines, a further constraint is that the people producing video have limited means of communicating specific context about their content unless they provide it as supplemental information, perhaps displayed on an adjacent web page. Yet as the Internet is experiencing a substantial growth boom in social networking and peer-to-peer video sharing, there is fast becoming an overwhelming glut of video content available. As such, viewers need a more manageable way to discern which videos will be most relevant or useful to their interests or needs.

Internet video delivery also represents an advancement in information delivery for commercial purposes. Its inherent entertainment factor brings the dynamic nature of television and film viewing into the everyday computer experience, creating the potential to dramatically increase viewership for content on any subject, accessible 24 hours a day from anywhere around the globe. Following the television model, sponsors of online video programming have seized the opportunity to embed advertising into online video content for maximum exposure. However, there still exists a myriad of problems with this scenario.

For example, the advertising exists as content separate from the main video, often with very little relevance to that video. Without a relevant or useful connection to specific context in the video, viewers typically ignore the advertising. Also, the advertising content is pre-determined by programmers, based on specific products or services they want to sell. However, in any given video, viewers might take interest in a variety of elements that could be purchased (objects or audio), yet they have no way to easily learn more details or where to buy. This represents a potentially significant window of commerce opportunities that are being missed.

### DESCRIPTION OF THE DRAWINGS

FIG. 1 is a diagram of the components of the system design for the client-side configuration.

FIG. 2 is a diagram of the components of the system design for the server-side configuration.

FIG. 3 is a diagram of the basic client and server interaction process when users interact with system-encoded video content.

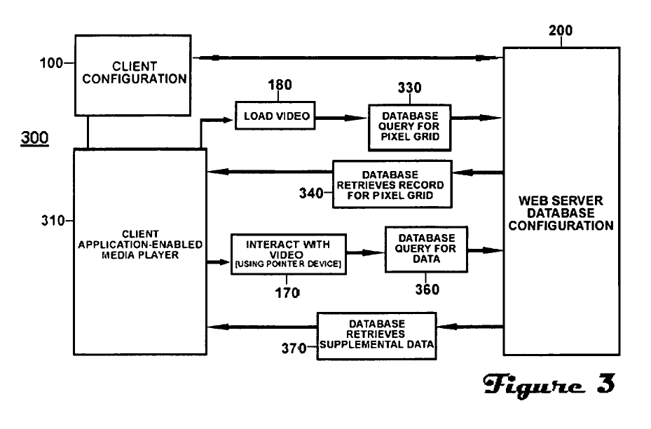

FIG. 4 is a diagram showing primary client-side actions and server-side response, including creating user accounts, adding and editing video content, and generating search queries related to video content.

FIG. 5 is a diagram of search query capabilities supported by the client and server sides of the system.

FIG. 6 is a diagram showing a client-side usage scenario of adding supplemental content for encoding into a video.

FIG. 7 is a diagram showing a client-side usage scenario of interacting with video using an options menu to view supplemental encoded content simultaneous with video playback.

FIG. 8 showing a client-side usage scenario of interacting with video using an options menu to defer supplemental encoded content to be saved to a favorites list for later viewing.

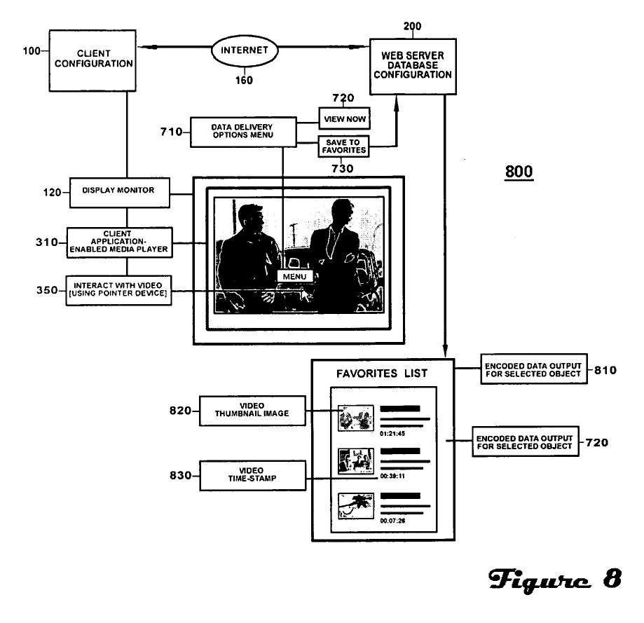

FIG. 9 is a diagram of another embodiment for the client-side configuration with system design for an Internet-enabled television set (Digital TV).

FIG. 10 is a diagram of another embodiment for the client-side configuration with system design for an Internet-enabled handheld device that supports digital video playback.

### DETAILED DESCRIPTION

The system provides advancements for video viewers as it introduces new capabilities and opportunities for acquiring knowledge and accessing resources related to specifics elements of interest in the content they are watching. For example, viewers watching video programming of a television show on their computer or a web-enabled Digital TV could mouse-click the screen where an intriguing vehicle appears, and seamlessly access Internet resources about that vehicle, such as logistical facts, price range, consumer report data, additional images, and hyperlinks to sponsor dealerships in their local area. Additionally, if music accompanies the video scene, the viewer could mouse-click another area of the screen to retrieve information about the music, such as song title, artist, and where they can purchase the music on the Internet. This spontaneous access, based solely on user choices and interests, is enabled by this system.

One component of the system has the ability for a viewer of a given online video to select objects within that video and add new supplemental content or edit existing content, e.g., by using a Wiki-based or other user-generated model that allows for communally enhancing the depth and breadth of information available for elements in that video. In this way, the system capitalizes on a global knowledge base of people willing to share their knowledge. In fact, the rapid growth of Internet blogging and online community discussion (and image and video) forums demonstrates that across the general public, there are hundreds of thousands of experts on an endless array of subjects, all of whom are quickly embracing the opportunity to share information with others who have similar interests.

Furthermore, this system addresses the common user needs for ease of use and platform-independence by providing a client application that is compatible with any media player and any video file format, and usable on any device capable of displaying video content, such as personal computers, hand-held media players, cellular phones, web-enabled television sets, and web-enabled projection systems. A user could install the client application, which could function as a plug-in to existing media player software. Users would then have on-demand access to encoded content already existing within videos they view, and have access to tools for adding and editing supplemental content related to specific elements in any videos.

The system increases the capabilities of video programming for showcasing commercial and educational opportunities. There exists an untapped potential for directly connecting video entertainment delivery with online consumerism in a way that more closely models traditional shopping. Consumers typically prefer to browse at their own pace and choose based on their own interests, rather than being spoon-fed what sponsors want them to see, when they want them to see it. The system embodies this crucial difference by allowing consumers the flexibility to view video entertainment and randomly choose information access based on objects or sounds that capture their interest in that video presentation.

Additionally, this system would allow viewers to interact with video to obtain information based on contextual layers of relevance and varying degrees of precision. For example, a viewer might click on the image of a man and then be able to choose whether they want information about the actor or, on a more granular level, the various objects of clothing he's wearing. Similarly, if elements in a video scene actually appear layered, such as a person seen through a window, the viewer would have the opportunity to select the precise object within the various layers about which they want information.

Today, funding for television and movie production relies heavily on product placement advertising, but the result is an overload of commercialism that may ultimately discourage viewership, turning every entertainment program into one long commercial. This system could advance traditional marketing and product placement further than is currently possible by enabling video programmers with the capabilities to encode video content with extensive data about objects and audio they anticipate as “desirable” to consumers. Marketing information, purchase point data, and Internet hyperlinks to sponsored resources could all be encoded as metadata assigned to specific objects or audio in any given frame of video. The result is a more pervasive, yet less obtrusive form of marketing, with a broader range of response data available to consumers in a single input (e.g., mouse-click, keystroke, touch or voice). Viewers would no longer be limited to a separation between their video viewing experience and their consumer interests. In the current video viewing experience, viewers may see elements that spark their interest, such as cars, gadgets, furniture, or locations, or hear music that appeals to them. To learn more about these items of interest, viewers then pursue the Internet to find details relevant to their needs, assuming they even know how to search for them. Typically, however, “desirable” elements displayed in television and films are more difficult to target, displaying no evident brand names that consumers can reference in their information search. With this system, consumers could now transparently traverse between mediums, enjoying video entertainment in tandem with the ability to randomly select objects of interest in the video to gain instant access to related information resources.

An additional aspect of this system is the ability to produce specialized versions of videos that are system-enabled to include consumer information and hyperlinks to purchase points specific to their business. For example, a purveyor of high-tech gadgetry might offer a system-enabled version of a new James Bond movie on DVD that allow viewers to click on objects viewed within the movie that can be purchased at their store. In this embodiment, a business might provide several versions of the encoded video: one that includes data access only to their own products; and another that provides Wiki-based information access, as well as the product-specific data access.

This system will also inject meaningful context into video content, which viewers can access at will. This added context can enhance and improve the viewing experience by providing additional detail not otherwise apparent on the surface, such as details about actors or characters, historical trivia, director's commentary, manufacturer references and purchase points. As a whole, these added layers of context for multiple elements throughout a video program can increase viewer perception of the video's value, which typically equates to increased viewership, which in turn makes the video more compelling to advertisers who gain increased access to more consumers.

Additionally, this system advances the educational usage of video programming. The system's encoded data linking between video content and the vast resources available on the Internet enables videos of any subject matter to extend the types and volume of information that can be communicated to viewers. As an example, viewers watching online broadcasts of sporting events might be interested to learn more about a specific athlete. Instead of watching the event and then searching the Internet for specific information, the present invention allows the viewer to simply mouse-click the video screen when a favorite player appears to instantly obtain statistical data about that athlete, as well as links to related merchandise for that player or team. Similarly, viewers of travel videos broadcast on the Internet could click the screen as it displays a village or specific building to learn more about that location, the local culture, geographic and demographic statistics, as well as hyperlink to language instruction organizations, currency exchange, travel planning, and safety tips. In other words, the many arenas of information that viewers of video programming would typically be interested to learn and motivated to pursue on the Internet would now be instantly available to them simply by watching the video and interacting with the screen at any desired time.

Furthermore, this system could be implemented in a range of environments, supporting a variety of pointing device mechanisms for interacting with video on-screen, including mouse pointers, stylus pointers, touch pads, roller ball pointers, computer keyboard access, voice activation, and touch-screen activation. In particular, the system in these embodiments could be employed in educational facilities that use video programming such as kiosks used in museums, schools, and event facilities, where voice and touch-screen interactivity is often used.

In addition, voice and touch screen interactivity for this system addresses a range of accessibility requirements and extends the opportunities afforded by the system to disabled viewers. For example, physically challenged viewers who cannot easily manipulate a mouse or keyboard could interact with video programming by touching the computer or television screen when an object, place, or sound of interest appears. Similarly, viewers could speak simple words to indicate their target of interest as it displays on the screen.

This system can also help solve the problem of information overload for viewers where video content and advertising are forced to compete for space. Currently, video content displays as a stand-alone component in a media player, with supporting content and advertising compressed into the limited space around it, or included in the video itself as part of the broadcast programming. The visual impact is often overwhelming for viewers as all the various elements of content vie for the viewer's fleeting attention span. This information overload often results in a majority of content being ignored or overlooked, its relevance and importance lost, which often means hundreds of thousands of advertising dollars go to waste. This information overload also diminishes or compromises the educational or entertainment value of video programming when key messages are not communicated effectively due to loss of attention or context. The system could help resolve this visual input overload by encoding a considerable amount of valuable data within the video itself, transparent to the viewer, with the information retrieved ad-hoc at the viewer's request.

With this system, video programming broadcasters can accomplish the same commercial objectives regardless of whether content is viewed within a small video window or in full-screen mode. Currently, full-screen viewing means that advertising sidebars are no longer visible or accessible to the viewer. In this system, viewers will interact with the video content directly to obtain information, thus, the screen display size does not inhibit their ability to make information choices related to the video.

Various embodiments of this system provide video programming audience with a seamless experience between their entertainment and educational viewing and their interest for information and consumer opportunities related to the content they are viewing.

Such embodiments bridge the gap between video programming and the information resources of the Internet, extending the user experience to help people acquire information in a way that is easier, faster, more efficient, and more personalized.

This system bridges the gap between video programming and user demand for instantaneous and specific access to information and commercial resources through a combination of video encoding mechanisms and interactive and search capabilities.

This system assumes that video program creation can be developed in a variety of manners. Subsequent video encoding pursuant to this system would be integrated as a follow-up step once the video program has been created. This encoded video programming can be delivered in analog, digital, or digitally compressed formats (e.g., MPEG2, MPEG4, AVI) via any transmission means, including Internet server, satellite, cable, wire, or television broadcast.

This system can function with video programming delivered across all mediums that support Internet access, including video content hosted on Internet-based servers or video content delivered on preformatted media such as CD-ROM, DVD or similar medium, any of which that can be viewed on an Internet-enabled computer, Internet-enabled television set (also known as Digital TV), Internet-enabled handheld device, or Internet-enabled projection system.

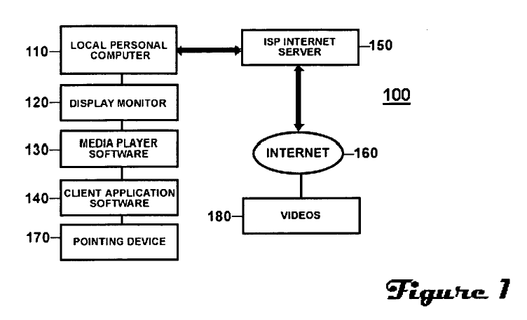

As shown in FIG. 1, an embodiment of this system shows the client-side configuration 100 whereby a user with a personal computer 110 that is connected to the Internet 160 through an Internet server 150 would use media player software 130 and also install the client application software of this system 140. This application 140 functions as a platform-independent plug-in for all existing media players 130, extending their current media players to include the functionality and toolset of this system. Users could then view videos 180 and access supplemental content encoded in those videos 180 using any number of pointing devices 170; add or edit content to a video 600 using a few tools 620, 630, 640; and query the system database 220 to search elements related to video data 360. Users could employ this system to view Internet-based videos 180 or watch disc-formatted videos 930 on such as CD-ROMs, DVDs or similar media.

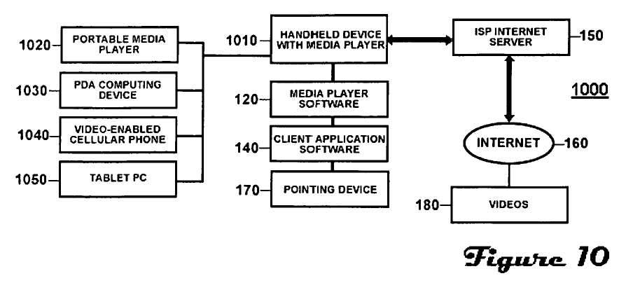

As shown in FIG. 10, another embodiment employs a handheld system 1000 with a client-side configuration whereby a person could use a handheld digital device 1010 such as a portable media player 1020, PDA computing device 1030, video-enabled cellular phone 140, or Tablet PC 1050. Like a desktop computer, the handheld device would be connected to the Internet 160 through an Internet server 150 and employ media player software 130 to view videos. The device would have the client application software of this system 140 installed, which would extend their current media players to include the functionality and toolset of this system. Users could view Internet-based videos 180 or watch disc-formatted videos 930 on such as CD-ROMs, DVDs or similar media.

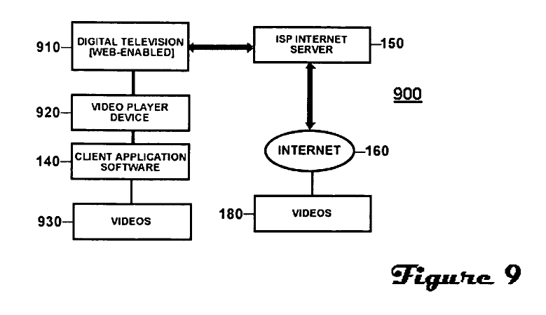

Another embodiment of the client-side configuration, as shown in FIG. 9, would support users who have an Internet-enabled television set 910 (also known as Digital TV). In this Digital TV system 900, the Digital TV 910 is connected to the Internet 160 through an Internet server 150, and the Digital TV computing system 910 serves as the media player and would allow installation of the client application software of this system 140, which would extend the Digital TV 910 to include the functionality and toolset of this system. Users could view Internet-based videos 180 or watch disc-formatted videos 930 on such as CD-ROMs, DVDs or similar media.

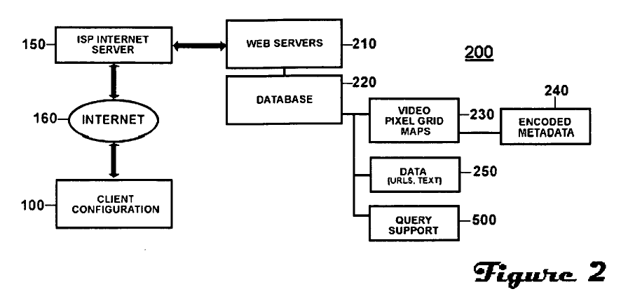

As shown in FIG. 2, an embodiment of this system shows the server-side configuration 200 whereby one or more Web Servers 210, which are connected to the Internet 160 through an Internet server 150, would employ one or more databases 220 to record, maintain and process data encoded pixel grids for videos 230, metadata 240 and supplemental content 250 related to the encoding. The system database 220 would also provide multiple search query capabilities 500 that enable users to search elements related to encoded video data.

This server-side of the system 200 would be connected to the client-side of the system 100 through the Internet 160 in a combined system 300, whereby users can load videos 180 locally, which sends a query 330 through the Internet 160 to the server-side of the system 200 to retrieve the appropriate pixel grid map 340 for that video, relevant to the video's file format and resolution. The pixel grid map 340 is a transparent overlay on the video screen that identifies the X, Y coordinates of any object in a given video scene. Those coordinates are referenced by the database 220 to verify and track user selections of objects 650, and to appropriately track groups of related pixels that constitute a single object, such as a person or vehicle. If the pixel grid map 340 already includes encoded data, the user can then interact 170 with the video using any number of pointing devices 170 to obtain supplemental information about a selected object or element in the video. Interacting with an encoded object sends a query 360 to the Web Server database 220, which in turn retrieves the supplemental content 370 and delivers it on the user's display device 120.

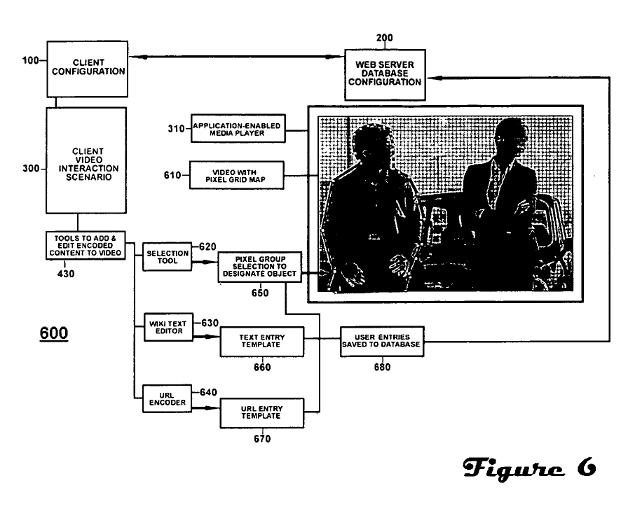

As shown in FIG. 6, the system would implement data encoding of video programming by overlaying each video frame with a pixel grid map 610 that segments an overall scene into a series of uniquely identifiable parts. Each pixel on the grid can have a unique identifier as well as a group identifier that designates it as part of a related group of pixels that form a distinct object, such as a person or a car. For each pixel group, within Line 21 of the vertical blanking interval (VBI) in the video, commonly used for closed captioning, both professional video programmers and amateur end-users could encode supplemental information related to the selected video object 650, such as textual references 630, and hyperlink URLs (Uniform Resource Locators) 640 to Internet addresses for elements such as images, audio, related videos, and other information that could be retrieved related to the objects in that grid space of the video. This pixel grid mapping of video scenes provides supports for an extensive amount of data to be encoded within a given video, extending the video programming with supplemental information and commercial resources instantly available to viewers.

In this embodiment, a user installs the client application 140 and then opens their media player 130 to view a video 180. The media player 130 would include a set of tools 620, 630, 640 related to this client application 140 and can be accessed via toolbar buttons and/or menus. If a video is currently loaded in the player 130, one specific tool button would appear active or enabled if the currently loaded video already contains encoded content, and would appear disabled if no encoded content yet exists. If encoded content exists, that information will consist of one of two primary reference types: either it is linked directly from an established online encyclopedia, in which case it cannot be edited in the client application 140; or it is information added by previous viewers using the client application 140 (i.e., the Wiki-based model of community contribution), in which case the content can be edited within the client application 140.

Another embodiment of this system allows for refreshed, time-based information retrieval from the assigned URL sources encoded in a video using the URL template 670 in the editing tools of the client application 140. Users can encode video with dynamically updating hyperlink URLs to ensure that encoded pixel grid maps reference the latest working Internet references, including accurate redirection to new resource locations.

When a user interacts with the media player 310 using some form of pointing device 170 to select an element in a video scene, they are, in effect, selecting a pixel on the pixel grid 340 that transparently overlays the video. The system then sends the input to be processed by a runtime that queries the database 360 to determine if that pixel is identified with any supplemental content (e.g., text or hyperlink URL references to images, audio, other videos, etc.). The system also identifies whether the selected pixel is part of a known group of pixels that relates to an object known by the system. Either way, the system retrieves any encoded content 370 for that pixel or pixel group and delivers it to the client application/media player 310 where the user can view the information.

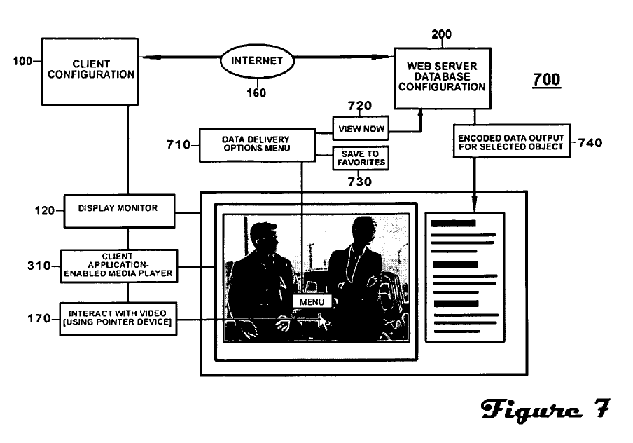

In one embodiment of this system, information retrieval for encoded video objects is real-time based on user interaction with video content, and data is displayed in a variety of formats based on viewer preferences, as shown in FIG. 7 as a real-time system 700. In one embodiment, when a viewer uses any form of pointing device 170 to select an object or sound element in a video, the video display pauses temporarily, and an options menu 710 is displayed, allowing the viewer to choose whether they want to view the related information immediately 720 or save it for later 730.

In one embodiment of the options menu 710, if the viewer chooses to view the information immediately, the encoded data output is displayed in an adjacent portion of the overall display window 740. With related educational and consumer information accessible to the viewer alongside the video display, information remains directly in context with what is being viewed in the video at any given time.

In another embodiment of the options menu 710, the viewer can defer browsing of the retrieved information by choosing to save the supplemental data to a list of favorites 810, much like bookmarking a Web page in an alternate system 800. The viewer can later review this favorites list 810 to access all available information for encoded video elements they selected earlier. One embodiment of this favorites list 810 would include a mechanism that saves a video-still thumbnail image 820 of the specific video scene wherein the object or audio selection was originally made, providing a visual reference to reinforce the context of the information requested. The video thumbnail image 820 would be stored on the favorites list 810 along with a time-stamped hyperlink URL 830 pointing to the specific point in the video where that scene occurs.

In one embodiment of this system, users can add new information to videos, as shown in FIG. 6. To do so, the user could use the application's selection tool 620, such as a freeform lasso, to outline a specific object onscreen. The selection tool captures a group of pixels on the pixel map and designates them as a group 650. The user could then add textual content 630 and/or hyperlinks to URLs 640 that are relevant to the selected object. The system will recognize and track other instances of that pixel group as they appears throughout the video and thus, replicate the added information segment(s) for that group of pixels such that every instance of the selected object is encoded with the same data. As a result, the user need only add the encoded data once for a given object, such as an actor, and that data will then be accessible if that actor is clicked on in any other scene in the video.

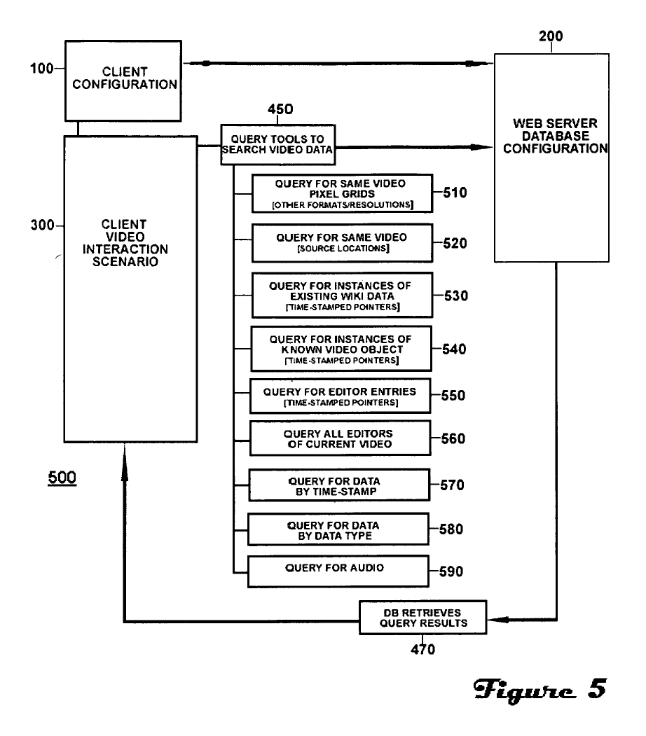

In one embodiment of this system, the server-side database 220 functions as a bi-directional database, in addition to tracking user input for video encoding, the system would inversely track the related videos that have been encoded using this system, tagging them with unique identifiers that can be searched by users. In this way, the system creates searchable video, examples of which are included in FIG. 5, which details some search query scenarios supported by the system.

For example, one embodiment of this search feature would allow users to query the database to locate references to all other videos that currently include a given a given information segment (also known as Wiki-entered data) 530 so it can be repurposed for their current use in encoding video, which helps avoid duplication of identical content and promote consistency of encoded content across videos with identical elements, such as the same actors, locations, events, or vehicles. For example, a user intending to add new content about a given topic, e.g., trivia about a specific actor, could first query the database to learn whether any related information segments already exist. If the system locates related instances, the user could add them to the current video, and, if the segment originated in this application 140, the user could edit that segment as well.

Another embodiment for the system's search functionality 500 would allow users to search for pixel grid maps 340 (encoded or not yet encoded) for other instances of a specific video that are of different file formats or resolution 510.

Another embodiment for the system's search functionality 500 would allow users to search for instances of a specific video across the Internet 160. The system database 220 would then retrieve records of hyperlink URLs to known source locations for that video.

A further embodiment for the system's search functionality 500 is that the database 220 would assign a time-stamp to each instance of an encoded object and the related data as it exists within a video. This allows users to search a video to find the next available scene where a specific element appears. Users could search for all instances of a specific encoded video object (as known by the system) 540, existing either in one specific video or across any video in which it might be present. For example, a viewer watching a television show online might see a compelling sports car in a scene and access supplemental content about it. They might then wish to locate all the other scenes in the current video where that car appears so they can get a better look at it from various angles. The user could query the database 220 to find other instances of that encoded segment in the video, and the search results would reference time-stamped hyperlinks to those instances in the current video (essentially links to other instances of the pixel grid map for that video), so the user could jump to those specific time points in the video.

Another embodiment for the system's search functionality 500 would allow users to search for all text entries by a specific editor 550 (of this Wiki-based system) in a specific video or across all videos where that editor might have contributed content. The database 220 would retrieve hyperlink URLs to all relevant videos, with each record time-stamped to allow users to jump to the relevant points in each video where that editor's content exists.

Another embodiment for the system's search functionality 500 would allow users to search for all editors who have contributed to a specific video 560. The database 220 would retrieve a list of names along with time-stamped hyperlink URLs such that users could jump to specific points in that video to view each editor's contributed content.

Another embodiment for the system's search functionality 500 would allow users to search for all supplemental data available for a given time-stamp in a video 570. While the system, by default would delivers all known supplemental data for a selected object in a scene at a given time point in a video, a user might want to access all data available for any element in that scene. A search query by time-stamp 570 makes this possible. For example, a user watching a video about the Civil War might want to find all available supplemental information relevant to a specific battle scene, such as the historical context, dates, location, historical objects such as machinery and artillery, characters involved, actors portraying those characters in the video, other videos that reference the same battle scene, and so on.

Another embodiment for the system's search functionality 500 would allow users to search within one video or across all known videos for encoded information of a specific data type 580. For example, a user viewing a historical biography of pharaohs in ancient Egypt might wish to retrieve links to all the date references (data type) in that video so they could jump to those points in the video to view scenes encoded with date or date range information. Similarly, they could search for all videos encoded with supplemental data for a specific date or date range.

Another embodiment for the system would allow users to search within the current video for all instances where the same or nearly identical audio elements exist 590. Using the editing functions 620, 630, 640 in the client application 140, when users encode supplemental data for a specific audio file, such as music, referenced in a video, the server system 200 automatically replicates the encoding onto any other pixel grids for scenes in the video where the same audio file is used. However, sound effects audio, such as screeching tire sounds for speeding cars, can be useful references as well, allowing users to cross-reference ambient sounds with their related objects. For example, a user could add encoding data about a given vehicle. The system would replicate that data for all scenes where that vehicle appears. However, as scenes might exist that include the sound effects without the visual of the vehicle; the user could query the database for any audio references 590 using keywords to describe the sounds. The database 220 would then interact with the servers 210 to identify the text-based closed captioning data in that video, hosted in Line 21 of the VBI signal for that video. The system could then flag any closed captioning text that matches the user's keywords, and then retrieve a list of time-stamped hyperlinks that allow the user to jump to specific points in the video where those sounds occur. Using the vehicle example again, the user could then review all the video scenes where the vehicle sound effects occur, and for any scenes that do not visually show the vehicle, the user could all the relevant encoded data or cross reference existing encoded data for that vehicle. Similarly, there might be scenes in which the same vehicle appears but in a form different enough that the server system 200 could not recognize it as the same object (for example, the vehicle had been damaged to affect its size and shape) and thus the system did not replicate the encoded supplemental data relating to that vehicle. In this event, searching based upon the audio references allows users to locate other instances in the video of that vehicle and add or cross-reference the appropriate encoded data. This feature provides for more comprehensive and accurate encoding throughout a given video.

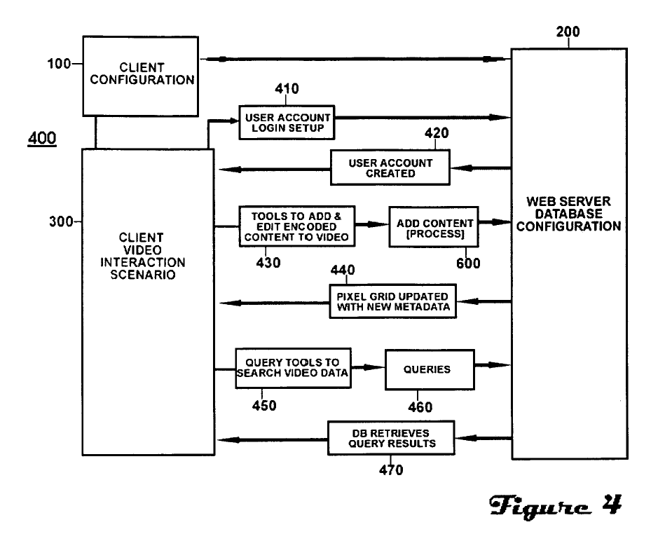

FIG. 4 illustrates a Wiki-based system 400. To preserve the integrity of the system and promote video encoding guidelines for this Wiki-based system 400, users wishing to add or edit encoded information can create a user account 410 that includes an unique username and password for login access, and an editor profile including name and contact information. The system database 220 would record and maintain each user ID 420. The login process will require users to read and accept a submission agreement that outlines guidelines for submitting information for encoded video. Once a user has a verified user account 420, they can add or edit content to the currently viewed video, and any subsequent videos viewed during that session. For each new viewing session using the client application 140, users can view video, but will be required to login again if they wish to add or edit encoded information segments to the video.

An additional embodiment of the user account 410 and editor profile feature could allow users to define preferences that target their individual interests and commerce needs, such as particular vehicles they are considering for purchase, places they intend to travel, genres of music they enjoy, and so on. User preferences would also capture demographic data such as age, gender, location, marital status, etc. In this embodiment, when the user selects an object or audio element in a video scene, the system would map the viewer's profile preferences to the data encoded in the video and deliver conditional results, providing information that is most relevant to that viewer. As an example, a common user profile variable is location, and as such, the system servers 210 and database 220 could process the user request from the client application 140 for a selected encoded object or audio element in the video and cross-reference it with user profile data, and then retrieve information relevant to the viewer's locale. For instance, a user based in Seattle could click on a vehicle of interest in a video and retrieve supplemental data that includes logistical and pricing details about the car, as well as purchase point hyperlinks to relevant dealerships in the Pacific Northwest. Similarly, a viewer watching a rock music video could click a musician in the video to access not only biographical data about that band member and other band information, but also the band's concert dates at event facilities in the viewer's area. To track location data, the server system 200 could reference the viewer's user profile if one has been created, or the system could detect viewer location based upon the accessing computer's Internet Protocol (IP) address, a data trail that is now commonly traceable down to the computer user's city.

Another embodiment of this system relates to adding and editing supplemental content for encoding into videos, as shown in FIG. 6 as an editing system 600. The client application 140 would include templates for text entry 630 and hyperlink URL entry 640. For users opting to add new information segments, the application would produce a template of form controls, some of which would require exclusive entries (such as defining the selected video element as a person, location, object, or audio, and in some cases, more granularly as animal, vegetable, mineral, and so on), while other form controls would allow for adding the textual content and/or hyperlink URLs. The template could also allow users to categorize their added information by type, for example, tagging their content as general trivia, geographical, biographical, historical, numerical, medical, botanical, physical, date/date range, or any combination of categories that makes sense to provide context.

In another embodiment of this system, the database would be programmed with a series of filters that act as approval monitors, such as using reference keywords that verify whether or not user-contributed content is appropriate for the general public. Additionally, for any URLs added as encoded content, the system would have a verifying engine to validate the hyperlinks for accuracy.

Another embodiment of this system would allow for variable levels of permission access on videos, allowing a community of users to designate certain encoded videos as private versus public. For example, online communities might wish to publish a public version of videos related to their events, products, or services, and also circulate specially encoded versions of the videos only within their group.

Another embodiment of this system refers to the precision with which users could select information by contextual layer. Suppose a video scene includes a man wearing eye glasses and is seen through a curtained window. The precise location within that video scene where the viewer touches the screen (e.g., with pointing device or hand) determines which layers of information they might access. For example, they might access a context menu as follows: if the user clicks the eye glasses in the scene, they could access information about either the glasses, the man/actor, the curtains, or the window because all four objects are present in that group of pixels on the pixel grid; if they click the man's body, they could access information about man/actor, the curtains, or the window; if they click the curtain area, they could access information about the curtains or the window; if they click the window area other than where the curtain exists, they could access information about the window. Similarly, if they click somewhere else in the scene, they could potentially access a new group of information or information about the video general.

To aid in precision selection of onscreen objects, particularly for viewers watching videos on a digital (web-enabled) television set, another embodiment of this system would include a remote control where by a selection tool would appear onscreen as a crosshairs cursor, allowing viewers to effectively target their object of choice. They could then press the application button to extract information about that object. A related embodiment to this feature would allow for specialized remote controls that include uniquely branded buttons referencing high profile businesses for online shopping, such as Amazon.com. For example, a user viewing a video could use the remote control to select an object of interest, press the Amazon button to view that company's purchase availability and details, and place an order immediately. In this case, the remote button sends input as a hyperlink to specified URLs on the company's Internet website, and the system displays the relevant content onscreen in a separate browser window.

Another embodiment of this system would track videos across multiple locations that exist in multiple file formats and resolutions. The system database 220 would maintain records of pixel grids of multiple resolutions for any given video 510, and these records would include URLs to source video locations. When a video is loaded in a media player enabled with the system client application 140, a process would query the database, which would identify whether an identical video, of the same or similar file format has been registered in the database. If so, the system would apply a known pixel grid to that video, thereby implementing the encoding-access features for the user. For a known video, the system will also recognize the video's screen resolution (e.g., 1024×768) and apply a pixel grid appropriate to the screen size. For instance, a database record might exist for a pixel grid of video A at 1024×768 resolution. A user loads the same video (video A) formatted to 320×240 resolution. Hence, the system loads a downsized pixel grid for video A that has been adjusted for 320×240 resolution and allows users the same ability to interact with encoded objects, even at the smaller screen size. This function is particularly important going forward as technologies for portable video devices, such as iPod®, cellular phones, PDAs, and other hand-held media players are rapidly growing in mainstream use.

Another embodiment supports multi-tasking users, i.e., individuals who watch video and simultaneously send email, instant messages, or cellular phone text messages about content they are viewing. In this embodiment, a user could load a video in the application-enabled media player on their computer, mobile device, or digital television set, select objects on the screen and choose from the context menu the specific content layer of interest (e.g., an actor's motorcycle jacket), and then review any existing encoded supplemental content. The user would then have two primary avenues of action: 1) modify encoded content by editing or adding new information; or 2) share the content with another person via email, instant messaging, cellular phone text messaging or SMS. The system would capture a thumbnail image of the current frame of video (or possibly send a copy of a thumbnail image already on file in the database) and send that image along with a copy of the encoded content (text, images, audio, or URLs), as well as hyperlinked reference to a source location of the originating video, to the recipient. In this way, the recipient could view the supplemental information along with some relevant context from the video, and access the video itself via the hyperlink. The hyperlink would reference a distinct time-stamp in the video so the user could jump directly to the point in the video the sender was referencing.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

1. A digital information system and method as shown and described.
